(19) United States
(12) Patent Application Publication
(10) Pub. No.: US 2026/0046950 A1
(43) Pub. Date: Feb. 12, 2026

(54) SYSTEMS AND METHODS FOR PAIRING WIRELESS DEVICES

(71) Applicant: The Chamberlain Group LLC, Oak Brook, IL (US)

(72) Inventor: Robert Jude AXTOLIS, Naperville, IL (US)

(21) Appl. No.: 18/795,889

(22) Filed: Aug. 6, 2024

(51) Int. Cl. H04W 76/14; G06K 19/06; H04W 76/11

(52) U.S. Cl. CPC H04W 76/14; G06K 19/06037; H04W 76/11

(57) ABSTRACT

A method for pairing an operating device with a control device. The method includes initiating a learning mode of the operating device and receiving an identifier associated with the control device while in the learning mode. The method includes analyzing the received identifier against a reference value, where the reference value can be stored to the operating device or identified from a previous interaction with the control device. In response to the operating device determining that the received identifier satisfies the reference value, the method further includes the operating device pairing with the control device.

### BACKGROUND

Wireless transmissions and communications are often used to communicate secure data or allow for a controlling party to control a device receiving the transmissions or otherwise communicating with the controlling party. Accordingly, ideally, a receiving party learns or is paired with the controlling party to ensure the receiving party only acts on transmission received from an intended and verified source. One such scenario in which wireless devices can be learned or paired with each other is for wirelessly controlled moveable barriers, where a control device wirelessly delivers commands to a movable barrier operating device for controlling operations of the operating device.

Using traditional learning or pairing practices, at a basic level, an operating device is placed in a learning mode and waits to receive a signal from a controlling device. Once the operating device receives a signal from a controlling device, the operating device stores the received signal as belonging to a paired device and, in the future, will operate based on receiving signals from the paired device.

### SUMMARY

The disclosed examples are described in detail below with reference to the accompanying drawing figures listed below. The following summary is provided to illustrate some examples disclosed herein.

Example solutions include systems and associated methods for pairing an operating device with a control device. The methods include initiating a learning mode of the operating device and receiving an identifier associated with the control device while in the learning mode. The methods include analyzing the received identifier against a reference value, where the reference value can be stored to the operating device or identified from a previous interaction with the control device. In response to the operating device determining that the received identifier satisfies the reference value, the methods further include the operating device pairing with the control device.

Example solutions include a method of pairing an operating device with a pairing device including initiating a learning mode of the operating device and capturing, by a sensing device of the operating device, a machine-readable code associated with the control device. The method further includes the operating device identifying from the machine-readable code a base identifier (ID) and then receiving a first signal from the control device. The method further includes the operating device identifying from the first signal a first signal ID and, in response to determining that the first signal ID includes the base ID, pairing with the control device.

Example solutions include a method of pairing an operating device with a pairing device including initiating a learning mode of the operating device and receiving an operation signal from a control device at the operating device. The method further includes the operating device determining a signal strength of the received operation signal and whether the signal strength if the received operation signal is greater than a signal strength threshold value. The method further includes the operating device pairing with the controlling device in response to determining that the signal strength of the received operation signal is greater than the signal strength threshold.

### BRIEF DESCRIPTION OF THE DRAWINGS

The disclosed examples are described in detail below with reference to the accompanying drawing figures listed below:

FIG. 1 illustrates a movable barrier system, according to an example of this disclosure;

FIG. 2 is a block diagram illustrating an example of a user-operated control device of the system of FIG. 1;

FIG. 3 is a block diagram illustrating an example of a movable barrier operator of the system of FIG. 1;

FIG. 4 illustrates a top view of a user-operated control device, according to an example of this disclosure;

FIG. 5 illustrates a top view of a user-operated control device, according to another example of this disclosure;

FIGS. 6-8 are diagrams illustrating interactions between a control device and an operator during a pairing operation, according to an example of this disclosure;

FIG. 9 is a flowchart illustrating a method of performing a pairing operation, according to an example of this disclosure;

FIGS. 10-11 are diagrams illustrating interactions between a control device and an operator during a pairing operation, according to another example of this disclosure; and

FIG. 12 is a flowchart illustrating a method of performing a pairing operation, according to another example of this disclosure.

Corresponding reference characters indicate corresponding parts throughout the drawings.

### DETAILED DESCRIPTION

Under traditional learning or pairing practices, an operating device is placed in a learning mode and waits to receive a signal from a controlling device. Once the operating device receives a signal from a controlling device, the operating device stores the received signal as belonging to a paired device and will thus operate based on future signals received from the paired device. However, this traditional practice is not always secure and can lead to unintended consequences, such as the operating device pairing with an unintended controlling device. That is to say, according to traditional learning or pairing practices, the operating device can learn or pair with any device that it receives a signal from while in the learning mode, including controlling devices not intended to be paired with or learned to the operating device.

For example, in a commercial warehouse setting, there may be numerous operating devices each operating its own movable barrier and all in close proximity to one another. In such settings, the control devices for the numerous operating devices are continually being activated in order to open and close barriers during the warehouse hours of operation. Because all the operating devices are in close proximity, and because of the high rate of frequency at which controlling devices are being activated within or around the warehouse, when one of the operating devices is placed in a learning mode, it is very likely the operating device will attempt to learn or pair with an unintended control device responsive to a signal received from the control device intended to control one of the other operating devices in the warehouse. Thus, it is often challenging to prevent the unintended control device from pairing or learning a given operating device in such scenarios.

This is just one of various similar scenarios used for illustrative purposes. For example, while in the learning mode, the operating device may receive a signal from a controlling device belonging to a next-door neighbor and thus pair with the neighbor’s controlling device. That is to say, according to traditional learning or pairing practices, the operating device can learn or pair with any device that it receives a signal from while in the learning mode, including controlling devices not intended to be paired with or learned to the operating device. Similar unintended pairings can occur in other commercial or residential settings, as those with skill in the art will understand.

As will be discussed in greater detail below, example solutions of this disclosure provide for secure pairing of devices, even in environments where signals from unintended control devices may be detected by the operating device during the learning mode.

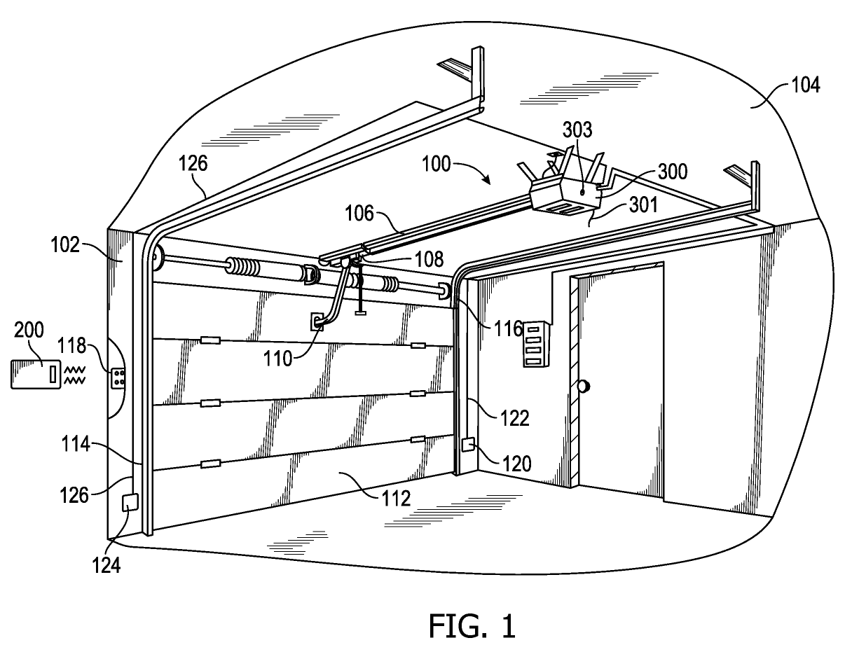

FIG. 1 illustrates a moveable barrier operator system 100 that includes a movable barrier operator 300 and a control device 200. As shown, according to some examples, system 100 is utilized in a garage 102 setting. Control device 200 can comprise any of various known control devices, such as, for example, a handheld device such as a remote control, a wall-mounted control device, a control device integral to a vehicle, or the like. In the illustrated example, operator 300 is mounted to the ceiling 104 of the garage 102 and includes a rail 106 extending therefrom with a releasable trolley 108 attached having an arm 110 extending to a barrier 112 positioned for movement along a pair of door tracks 114, 116. In this example depicting a garage 102 setting, barrier 112 comprises a garage door. Control device 200 is adapted to send signals to and receive signals from the operator 300. An antenna 301 may be positioned on the operator 300 and coupled to a receiver as discussed hereinafter in order to receive transmissions from the control device 200. An external control pad 118 may also be positioned on the outside of the garage 102 and include a user interface thereon for receiving user commands that are communicated via radio frequency transmission with the antenna 301 of the operator 300. In some examples, the external control device 118 is accessible from an outside location and in some examples constitutes a control device 200. An optical emitter 120 may be connected via a power and signal line 122 to the operator 300 with an optical detector 124 connected via a wire 126 to the operator 300 in order to prevent closing of the barrier 112 on a person or object inadvertently in the door’s path. An input such as a button or switch 303 may be provided for switching the operator 300 between modes, such as operating mode and learn mode. FIG. 1 depicts an illustrative example of a movable barrier system according to one example of this disclosure in a garage environment, and those with skill in the art will recognize that various other movable barrier examples in various other settings fall within the scope of this disclosure. For example, other movable barrier environments of this disclosure include environments such as over-head doors used for bays, room dividers, gates, and any other movable barrier controlling or providing access to an area.

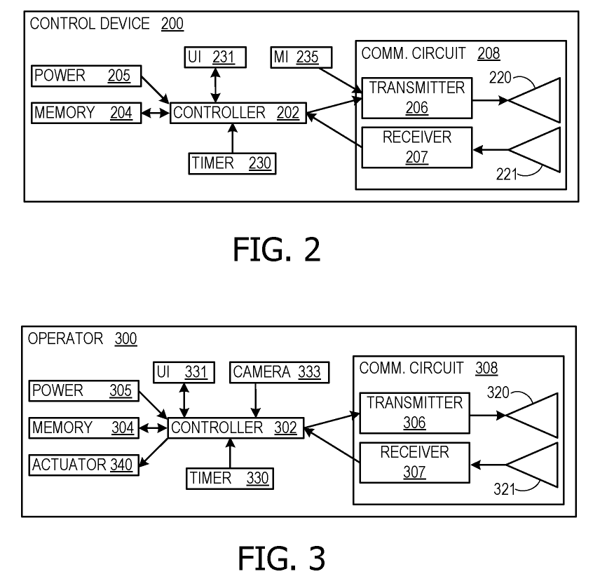

FIG. 2 illustrates a block diagram of the control device 200. Control device 200 includes a communication circuit 208 comprising both a transmitter 206 and receiver 207 (which may be combined into a single transceiver mechanism) in operative communication with antennas 220 and 221, respectively. The antennas can be positioned in, on, or extending from the control device 200,wherein the transmitter 206 and receiver 207 are configured for wirelessly transmitting and receiving transmission signals to and from the operator 300, including transmission signals that contain a first rolling access code with a fixed code portion and a rolling code portion. In some embodiments, both the transmitter and receiver may communicate with a single antenna or multiple antennas, and in some examples the transmitter and receiver may be configured to be a single transceiver device in communication with a single antenna. Control device 200 also includes a controller 202 in operative communication with the transmitter 206 and a memory 204 and is configured for processing data and carrying out commands. The memory 204 may be, for instance, a non-transitory computer readable medium, and may have stored thereon instructions that when executed by a controller circuit cause the controller circuit to perform operations. A power source 205 is coupled to the controller 202 and/or other components, and may be routed in some embodiments so that a user interface (UI), such as UI 231, couples/decouples the power source to other components so that power is supplied only upon activation of the UI 231 or a specified time thereafter. Controller 202 is configured to generate the transmission signal with a signal identifier and cause the transmitter 206 to transmit the signal, and the receiver 207 is configured to receive responsive transmissions from one or more operators 300. Optionally, a timer 230 in communication with the controller 202 enables the controller 202 to determine the time of incoming and outgoing signal transmissions and provides reference for the controller 202 to enable and disable the transmitter 206 and/or receiver 207 of the device. In some embodiments, a manual setting interface (MI) 235 may be provided, which in some forms may include one or more dual in-line package (DIP) switches or other devices configured to allow a user to configure a setting or state of the controller 202. MI 235 may be operatively coupled to the transmitter 206 in order to allow for signal transmissions including information regarding the current setting or state of the manual setting interface. Memory 204 is connected for operative communication with controller 202 and is configured to store data such as codes and, in some examples, other information for outgoing transmissions. Memory 204 is further configured to store fixed and/or changing or variable code information for comparison to incoming transmissions.

UI 231 may include one or more user-operable switches for inputting commands to the control device 200, for example to issue a barrier movement command or a learning command. UI 231 may be associated with a button, lever, or other device to be actuated, for example by a user’s hand or other actions, events, or conditions. As other examples, the UI 231 may be voice operated or operated by a user contacting a touch-sensitive screen as the location of an object displayed on the screen. The UI 231 may include multiple buttons, levers, switches, displays, microphone(s), speaker(s), or other inputs associated with different tasks, or operations, to be carried out by the operator 300. As one example, the UI 231 includes a plurality of mechanical buttons that each operate a respective switch. As another example, UI 231 includes a display with one or more virtual buttons.

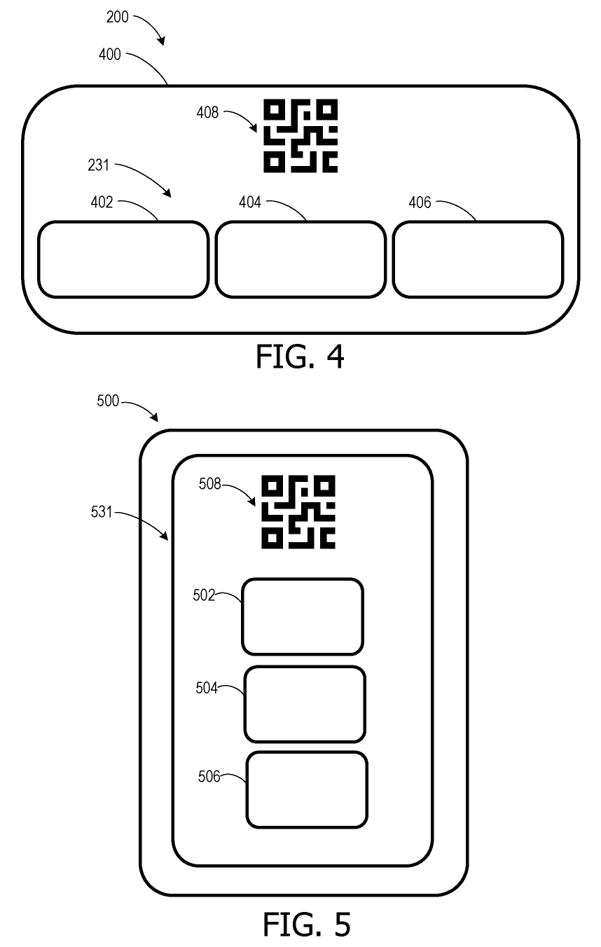

FIG. 3 illustrates a block diagram of operator 300. According to various examples, the operator 300 includes a controller 302 in communication with a memory 304 and is configured for storing and retrieving data to and from the memory 304 as well as processing data and carrying out commands. A power source 305, such as an AC power conduit, battery, or other type of power source, supplies electricity to the controller 302 to allow operation. As an example, power source 305 may include an AC power conduit, a power conditioning circuit, a battery, and/or a battery charging circuit. Operator 300 also includes a communication circuit 308 comprising a wireless transmitter 306 and receiver 307 (or combination transceiver device) in operative communication with the controller 302. As shown, transmitter 306 communicates with a first antenna 320 and receiver 307 communicates with a second antenna 321, but both devices may communicate with a single antenna or multiple antennas, and in some embodiments the device may be configured to have a single transceiver device in communication with a single antenna. The antennas may be positioned in, on, or extending from the operator 300. In this regard, signals, such as radio frequency or other wireless transmission carriers, may be sent to and received from the control device 200 according to a variety of frequencies or modulations. Signals may be modulated in a number of different ways; thus, the control device 200 and movable barrier operator 300 may be configured to communicate with one another via a variety of techniques. Controller 302 of the operator 300 is also in communication with an actuator such as an actuator 340 in order to carry out an operation such as moving a barrier, which may include for example lifting or lowering a bay or a garage door; sliding, swinging, or rotating a gate; or otherwise moving or repositioning a barrier structure. Actuator 340 can comprise any actuating device for moving the associated movable barrier, such as, for example, a motor, a pneumatic or hydraulic actuator, a linear motion actuator, a rotary actuator, or the like.

User Interface (UI) 331, which includes one or more input devices such as buttons, keys or a touch-screen interface, for example, receives user input to override the controller 302 or place the controller in and out of a learning mode in which the operator 300 may be paired with a user-operated device, such as control device 200, by exchanging and storing messages. Operator 300 further includes a sensing device, which in some examples is a camera 333. As will be discussed in greater detail below, camera 333 is used to scan or otherwise identify or capture machine-readable codes for processing by controller 302. Accordingly, in some examples, camera 333 can be simply a scanning tool, or in some examples can be a camera for capturing images and detecting machine-readable code from the captured images.

The term controller refers broadly to any microcontroller, application specific integrated circuit (ASIC), field programmable gate array (FPGA), computer, state machine, or processor-based device with processor, memory, and programmable input/output peripherals, which is generally designed to govern the operation of other components and devices. It is further understood to include common accompanying accessory devices. The controller can be implemented through one or more processors, microprocessors, central processing units, logic, local digital storage, firmware, software, and/or other control hardware and/or software and may be used to execute or assist in executing the steps of the processes, methods, functionality, and techniques described herein. Furthermore, in some implementations the controller may provide multiprocessor functionality. These architectural options are well known and understood in the art and require no further description here. The controllers may be configured (for example, by using corresponding programming stored in a memory as will be well understood by those skilled in the art) to carry out one or more of the steps, actions, and/or functions described herein.

When a user actuates UI 231 of the control device 200, such as by pressing a button designated as performing a particular action, the controller 202 activates the transmitter 206 to transmit through antenna 220 a message based on information stored in the memory 204. The message is received by the receiver 307 of operator 300 and communicated to the operator’s controller 302. In some embodiments, the controller 302 verifies the message by comparing the message to stored information from the operator’s memory module 304, and upon verification the controller 302 is configured to cause transmission of a response signal from the transmitter 306 through antenna 320. If the message from the user-actuated control device 200includes information relating to timing parameters for a response, the operator’s controller 302 receives time information from a timer 330 in order to determine when to transmit the response in order to comply with timing parameters of the control device 200.

The control device 200 may be configured to verify that the response from the operator 300 complies with transmitted timing requirements in any number of ways. In some embodiments, controller 202 may compare a time stamp or other timing information relating to the operator’s response to the transmitted time parameter using timer 230. In some embodiments, receiver 207 is generally inactive, but switched on by controller 202 only for a short time period consistent with the transmitted timing parameter. For instance, controller 202 may switch on receiver 207 for a window of time matching a time window transmitted in an outgoing message through transmitter 206, and upon expiration of the time window according to timer 230, controller 202 switches receiver 207 off again. Timing information may be either relative, for instance a specified number of seconds, milliseconds, or nanoseconds after transmission of an outgoing signal or other event, or may be absolute such as standard date and time information for a specific time zone. A timing synchronization protocol may be provided in some forms in order to maintain precision of timing with other devices despite drift or other factors.

As discussed, communication circuits 208, 308 can comprise two-way communication circuits configured to both transmit and receive communications signals. In some examples, communication circuits 208, 308 comprise short-range wireless communication modules, such as Bluetooth or Bluetooth low energy (BLE) modules or circuits, for example. According to various other examples, communication modules 208, 308 can be configured to only transmit or receive signals rather than being configured for two-way communication. For example, in some variations, communication circuit 208 is configured to transmit control signals and communication circuit 308 is configured to receives the control signals in a unidirectional

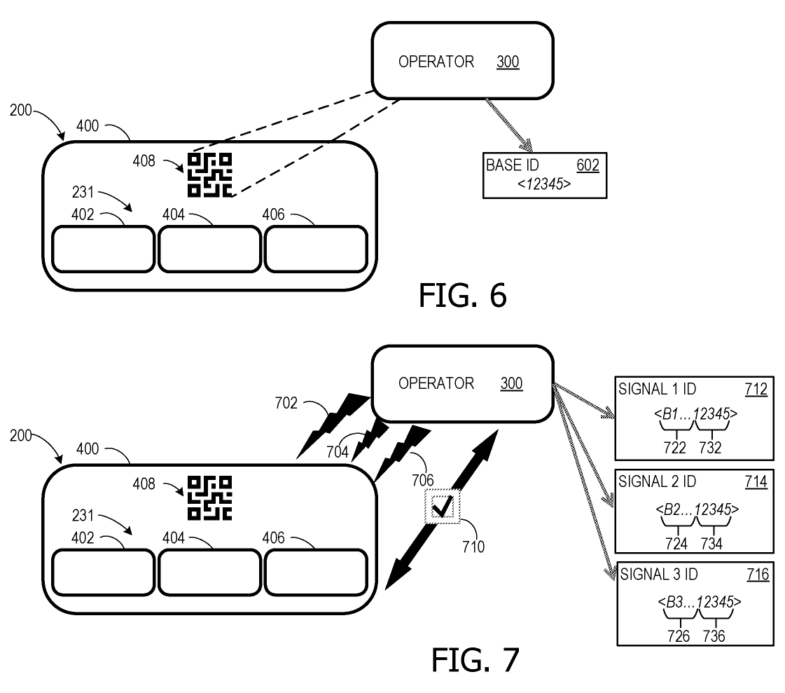

FIG. 4 illustrates a control device 200 according to an example of this disclosure. Control device 200 includes a housing 400 which houses various components depicted and discussed in FIG. 2. Housing 400 can comprise or be made of a material to allow for transmissions to be received and/or sent from communication circuit 208 housed therein, such as, for example, a plastic material. In this example, UI 31 includes depressible buttons 402, 404, 406 which can be activated by the user. As previously discussed, each button 402-406 can be activated by the user to cause or activate a different action by operator 300. Although UI 31 is depicted as including three buttons 402-406, those with skill in the art will recognize that, according to various examples, control devices herein can include more or less than three buttons. Control device 200 further includes a machine-readable (MR) code 408 displayed on an outer surface of housing 400. As will be discussed in greater detail below, MR code 408 provides device-specific information of control device 200 to a scanning device. For example, machine-readable code 408 can provide information related to a global unique identifier (GUID), which is an identifier unique to each control device, similar to a serial number, and is included in each transmission sent from control device 200 for identifying the source of the transmission. MR code 408 is displayed on housing 400 so that it can be scanned from the of outside housing 400. MR code 408 can be included as part of housing 400 according to any of a number of methods. For example, MR code 408 can be a sticker secured to the outside of housing 400. In other examples, MR code 408 is etched or engraved into or is otherwise integral with housing 400. As illustrated, MR code 408 can be a QR code, but can comprise any other type of known machine-readable code, such as a barcode, in some examples.

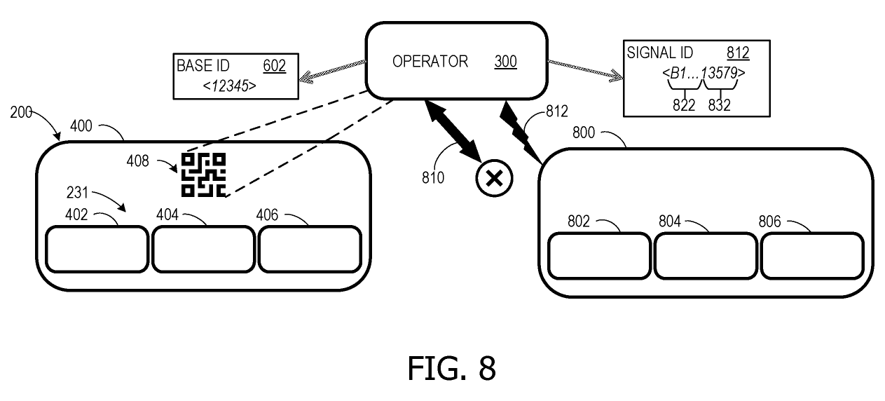

FIG. 5 illustrates a control device 500 according to another example of this disclosure. Control device 500 is substantially the same as control device 200 previously discussed. However, the UI 531 of control device 500 is a touch-screen UI 531. As shown, instead of physical buttons (such as buttons 402-406 previously discussed) control device 500 includes virtual buttons 502-506 displayed on UI 531 which can be tapped or otherwise engaged by a user to provide desired commands to the operator. Additionally, instead of being part of a housing of control device 500, control device 500 displays a MR code 508 (substantially the same as MR code 408) on UI 531. Although control device 200 will be referenced throughout this disclosure, those with skill in the art will recognize that, according to various examples, control device 500 is used to perform the various methods and operations described herein.

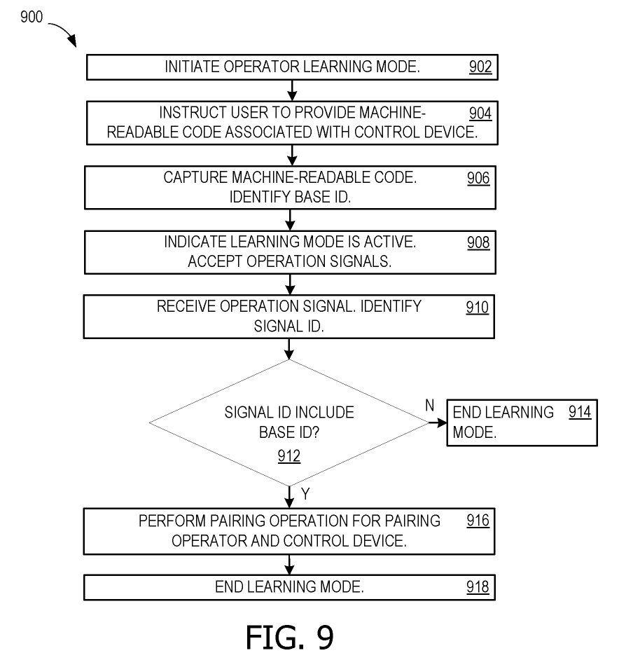

FIG. 6 is a diagram illustrating interactions between operator 300 and control device 200 in performing a pairing or learning operation. Herein, the terms “pairing” and “learning” are used interchangeably. That is, operator 300 being paired with control device 200 has the same meaning as control device 200 being learned to operator 300, or as operator 300 being learned to control device 200. As those with skill in the art will recognize, pairing control device 200 and operator 300 is done to so that the operator 300 will recognize signals from control device 200 as coming from a device intended to control operator 300 and will take action based on those signals accordingly. Additionally, the pairing allows control device 200 to receive and process signals from operator 300. As previously mentioned, the operator 300 is first placed in a learning mode by a user via operator UI 331. After placing the operator 300 in learning mode, the user presents MR code 408 to be processed using operator camera 333. From this processing, controller 302 is able to determine a base identifier (ID) 602 associated with the control device 200. As previously mentioned, the base ID 602 can be referred to as a global unique identifier (GUID) and is a unique identifier assigned to control device 200. That is, each control device has its own unique base ID unique and specific to that control device which can be accessed via processing of MR code 408. For illustrative purposes, base ID 602 of control device 200 is shown as being “12345”.

FIG. 7 is a diagram illustrating interactions between operator 300 and control device 200 in performing a pairing or learning operation. After the operator 300 identifies the base ID 602 from MR code 408, the operator receives a signal, such as one of operation signals 702, 704, and 706, from control device 200 via receiver 307. Specifically, control device 200 transmits operation signal 702 in response to button 402 being activated by the user, control device 200 transmits operation signal 704 in response to button 404 being activated by the user, and control device 200 transmits operation signal 706 in response to button 406 being activated by the user. Only one of buttons 402-406 needs to be activated by the user after the MR code 408 is processed by the operator 300, but all three signals 702-706 are illustrated to show that any signal from control device 200 can be used in the pairing operation. Each transmitted signal 702, 704, 706 includes a signal identifier (ID) 712, 714, 716. Specifically, signal 702 comprises a signal ID 712, signal 704 includes a signal ID 714, and signal 706 includes a signal ID 716.

Operator controller 302 processes the received signal 702-706 and identifies the associated signal ID 712-716. Using signal ID 712 as an example, each signal ID includes multiple data sections that can be processed by operator controller 302 and in some examples is a protocol data unit (PDU) comprising various protocol, control, and device data. As shown, signal ID 712 includes a signal section 722 and a base ID section 732. Signal section 722 identifies the source of signal 702. For example, signal section 722 identifies that the first button 402 was pushed to generate signal 702, and thus is depicted in this illustrative depiction as starting with “B1”. In addition to identifying the button source of the signal 702, signal section 722 can define various other data, such as, for example, the command associated with button 402 being pressed, such as actuating door 24, for example. Signal ID 712 further includes a base ID section 732 which a section of signal ID 712 identifying the base ID associated with the control device 200. Control device 200 can include base ID 602 in the base ID section of every transmission from control device 200. Accordingly, as shown, base ID section 732 reflects base ID 602, which is “12345” in this illustrative example. Similarly, signal IDs 714, 716 each include respective signal ID section 724, 726 and base ID sections 734, 736. As shown, each base ID section 732, 734, 736 includes base ID 602.

After processing the signal 702, 704, 706, operator controller 302 determines whether the base ID section 732, 734, 736 matches or includes the base ID 602 identified from MR code 408. In response to determining that the base ID section 732, 734, 736 matches or includes base ID 602, such as in the FIG. 7 examples, operator 300 pairs with control device 200, as depicted by arrow 710. Specifically, to pair with control device 200, operator 300 stores base ID 602 and/or signal ID 712, 714, 716 to memory 304 as belonging to a control device that has be verified and properly learned during the learning operation. Thus, the operator 300 will receive and process future signals from the paired control device 200 in response to identifying that the signals include the stored base ID 602 or signal ID 712, 714, 716.

FIG. 8 is a diagram illustrating interactions between operator 300 and control device 200 unsuccessfully performing a pairing operation. Just as previously discussed in FIG. 6, operator 300 scans MR code 408 to identify the base ID 602 associated with control device 200. Next, as previously discussed, the operator attempts to verify that a signal from control device 200 also includes base ID 602. However, instead of receiving a signal from control device 200, operator 300 receives a signal 812 from control device 800. Control device 800 can be substantially similar to control device 200 and can transmit signal 812 in response to button 802 being activated. Operator controller 302 processes signal 812 and identifies signal and base ID sections 822, 832. As shown, base ID section 832 includes a different base ID (“13579”) than base ID 602 (“12345”). Accordingly, operator controller 302 determines base ID section 832 in received signal 812 does not include base ID 602 from MR code 408 and thus does not pair with control device 800, as depicted by arrow 810.

Those with skill in the art will understand the practical convenience, efficiency, and security associated with the pairing operations discussed in FIGS. 6-8. Specifically, operator 300 begins pairing with a desired control device 200 by identifying a base ID 602 associated with the control device 200 by scanning MR code 408. From this, operator 300 knows to look for device signals including the base ID 602 and to pair with the device associated with those signals. If the operator determines that a signal received during the learning mode does not include the base ID 602, the operator 300 will not pair with that device. As an illustrative example, referring to FIG. 8, a homeowner may be in the process of pairing operator 300 with control device 200. Right after the homeowner scans MR code 408 with operator 300 and before the homeowner can push one of buttons 402-406 to verify the base ID 602, the homeowner’s neighbor may activate their control device 800 and transmit signal 812 which is received by operator 300 during the learning mode. In traditional learning mode operations, if an operator detects a signal during the learning mode operation, it will pair with the control device that sent the signal – thus, a homeowner could inadvertently pair their operator with a neighbor’s control device. However, in examples according to this disclosure, the operator 300 detects that the received signal 812 does not include the correct base ID 602 and thus does not pair with the neighbor’s control device 800.

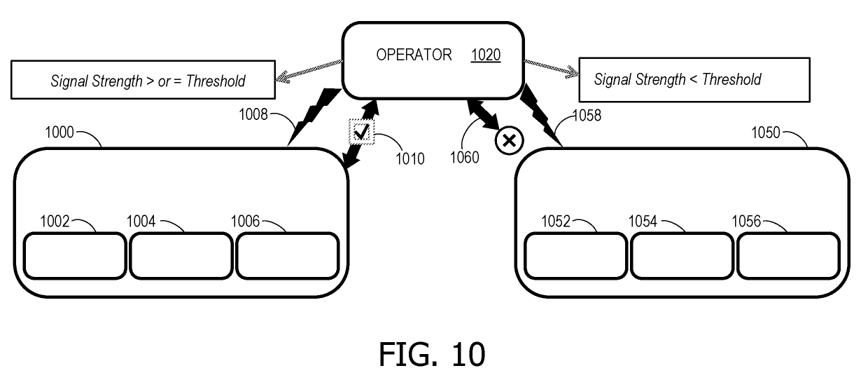

FIG. 9 is a flowchart illustrating a method 900 of performing a learning operation for pairing an operator with a control device, such as operator 300 and control device 200, for example. Method 900 can begin at block 902 by a user initiating a learning mode of the operator 300. Specifically, the user can use operator UI 331 to initiate the learning mode. Method 900 can optionally continue to block 904 by providing an instruction to the user to provide MR code 408 for scanning or capturing by camera 333. Specifically, operator controller 302 can control a display of UI 331 to provide a message instructing the user to position the MR code 408 in the field of view of camera 333. Method 900 can continue to block 906 by controller 302 capturing the MR code 408 with camera 333 and identifying the base ID 602. Method 900 can continue to block 908 by first optionally indicating the learning mode has been activated. For example, controller 302 can use a display of UI 331 to display a message that a restricted learning mode with a device having the base ID 602 has been initiated. Further, the instruction can include an instruction directing the user to activate a button of control device 200 to continue the pairing operation. Block 908 further includes controller 302 accepting operation signals for processing in the learning mode via communication circuit 308. Method 900 can continue to block 910 by controller 302 receiving an operation signal via communication circuit 308 while in the learning mode and identifying a signal ID of the received signal. Method 900 can continue to block 912 where controller 302 determines whether the signal ID of the received signal includes the base ID 602.

In response to determining the received signal does not include the base ID 602 (such as signal 812), method 900 continues to block 914 and the controller 302 does not pair with the device that sent the signal (device 800) and ends the learning mode. According to various embodiments, block 914 includes additional steps, such as providing instruction to the user to try previous blocks of method 900 again, or to continue listening for a signal that does include the base ID 602, for example.

In response to determining that the received signal does include the base ID 602 (such as signals 702, 704, 706), the method continues to block 916 where the controller 302 pairs with the control device 200 that sent the signal by engaging in a pairing operation. Those with skill in the art will recognize that there are various known operations that can employed by operator 300 and control device 200 to pair with each other in block 916. According to various examples, such as examples in which control device 200 broadcasts signals to operator 300 unidirectionally, this includes controller 302 storing the base ID 602 and/or signal ID 712, 714, 716 to memory 304 as IDs belonging to a paired device so that operator 300 can act upon future signals including the base ID 602 or signal ID 712, 714, 716. In some examples, such as examples where control device 200 and operator 300 communicate via a bidirectional communication connection, pairing operation 916 includes at least one of the devices learning a changing code sequence from the other device, and in some examples, may involve bidirectional learning so that each device receives and stores a series of fixed and changing code values from the other device. U.S. Patent No. 10, 652743 describes various exemplary pairing operations that can be performed by operator 300 and control device 200, and is herein incorporated by reference. Those with skill in the art will recognize various other pairing operations can be performed in block 916 to pair control device 200 and operator 300. After the control device 200 and operator 300 are paired with each other, method 900 can continue to block 918 by operator 300 ending the learning mode operation.

Although method 900 depicts blocks 902-918 as being performed in a certain order, those with skill in the art will understand that blocks 902-918 can be performed according to various orders without departing from the scope of this disclosure. Additionally, certain blocks can be removed from or added to method 900 without departing from the scope of this disclosure.

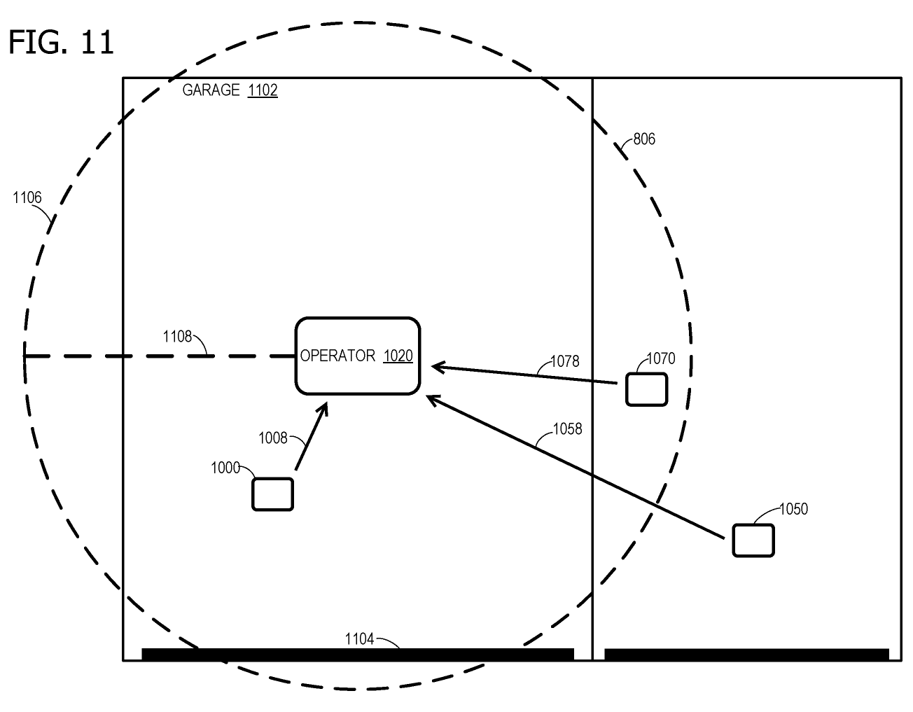

FIG. 10 is a diagram illustrating interactions between an operator and control devices in a learning or pairing operation, according to another example of this disclosure. Specifically, FIG. 10 illustrates an operator 1020 and control devices 1000, 1050. Operator 1020 is substantially the same as operator 300 previously described. However, the pairing operation depicted in FIG. 10 is configured to be performed without the use of a camera 333 or scanning device, so, in some examples, operator 1020 does not include a camera 333. However, those with skill in the art will understand operator 300 can also perform the pairing operations depicted in FIG. 10. Control devices 1000, 1050 are substantially the same as control device 200 previously described. However, since the pairing operation performed in FIG. 10 does not use a camera, in some examples, control devices 1000, 1050 do not include a MR code 408. However, those with skill in the art will understand that control device 200 can also perform the pairing operation depicted in FIG. 10. In some examples, the pairing operation depicted in FIG. 10 is an alternative or backup pairing operation that can be performed by operator 300, such as in the event camera 333 is not working or MR code 408 is damaged, for example.

Operator 1020 is configured to pair with control devices 1000, 1050 based on determining that a received signal strength from the control device 1000, 1050 satisfies a predetermined threshold value. For example, as shown, operator 1020 can be placed in a learning mode and can receive an operation signal 1008 from control device 1000. Specifically, the user can activate one of buttons 1002, 1004, 1006 to transmit operation signal 1008. Signal 1008 and other signals herein are referred to as an “operation” signals because, during normal operation when operator 1020 is not in the learning mode, signal 1008 is used to provide operation commands to operator 1020 (i.e., such as “open barrier” or “close barrier” operation commands, for example). That is, signal 1008 is not a signal specific to the learning mode, but is simply a signal transmitted by control device 1000 in response to one of operation buttons 1002-1006 being pressed.

Receiver 307 can measure and report the signal strength of signal 1008 to operator controller 302 to thus determine the received signal strength of the operation signal 1008 and determine whether the signal strength is greater than a predetermined acceptable signal strength threshold value. Specifically, in some examples, operator controller 302 can determine the signal strength of operation signal 1008 using a Received Signal Strength Indicator (RSSI). As those with skill in the art will recognize, RSSI is a term to measure the relative quality of a received signal and can measure the quality on a scale defined by the manufacturer. Accordingly, as an illustrative example, receiver 307 reports the received signal strength of signal 1008 to operator controller 302 which can measure the RSSI of signal 1008 using a predefined 0-100 RSSI scale. According to other examples of this disclosure, the strength of signal 1008 can be measured using an absolute value such as a decibel-milliwatts (dBm) value, for example, and compared to a predetermined acceptable threshold dBm value to determine pairing. Using a RSSI scale will be discussed in detail herein, but those with skill in the art will understand operator 1020 can process received signals using an absolute value, such as dBm, according to various examples of this disclosure.

As shown, operator 1020 determines the signal strength of signal 1008 and determines whether the signal strength is greater than the predetermined threshold value. For example, the predetermined threshold value can be stored to memory 304 and can be established by either the manufacturer or owner of operator 1020. As an illustrative example, the threshold value can be set to 50 on the RSSI scale of 0-100. As an illustrative example, controller 302 can determine that the RSSI value of signal 1008 is 60 and therefore is greater than or equal to the threshold value. Accordingly, operator 1020 can pair with control device 1000, as depicted by arrow 1010. Operator 1020 can pair with control device 1000 according to the various methods and operations previously described, such as by storing the GUID and/or signal ID associated with signal 1008 to memory 304 as being associated with a paired device.

Operator 1020 will not pair with devices transmitting a signal with a signal strength below the threshold value. As an illustrative example, a user engages one of control device 1050 buttons 1052, 1054, 1056 to transmit signal 1058 and signal 1058 is received by operator 1020. Operator controller 302 determines the signal strength of signal 1058 to be 40 on the 0-100 RSSI scale, and thus determines that the signal strength of signal 1058 is below the threshold value of 50. Accordingly, the operator 1020 does not attempt to connect with control device 1050, as depicted by arrow 1060.

Singal strength is used to determine a relative proximity of a control device attempting to pair with operator 1020. The closer the control device is to the operator 1020 when transmitting an operation signal, the stronger the signal strength will be when received by the operator 1020. Thus, operator 1020 will only pair with control signals in close proximity to the operator 1020 (those with relatively strong signal strengths) and not with those further away (those with relatively weak signal strengths). As previously discussed, traditional operators will pair with the control device of any signal received during the operator’s learning mode, regardless of the signal strength of the received signal. Accordingly, a homeowner may be in the process of pairing their control device with their operator and may inadvertently pair with the neighbor’s control device activated during the learning mode, even though the signal strength of the neighbors control device is very weak at the homeowner’s operator.

For example, FIG. 11 is a diagram illustrating and exemplary use of the pairing operations of operator 1020. Operator 1020 is installed in a homeowner’s garage 1102 for operating garage door 1104. The RSSI signal strength threshold value substantially corresponds with the area of garage 1102. The signal strength threshold hold value corresponds with a pairing proximity 1106 of operator 1020 having a paring radius 1108. That is, since signal strength can be correlated to a proximity of the control device to the operator 1020, any signals transmitted from a control device within pairing proximity 1106 will have a signal strength greater than the threshold value and any signals transmitted from a control device outside of pairing proximity 1106 will have a signal strength less than the threshold signal strength value. So, in this example, signal 1008 of the homeowner’s control device 1000 is within proximity 1106 and is found to have a signal strength of 60 which is greater than the threshold value of 50 on the 0-100 RSSI scale. Accordingly, the operator 1020 pairs with the homeowner’s control device 1000. Neighbor’s control device 1050 is outside of proximity 1106 and thus signal 1058 has a signal strength less than the threshold value, and in this particular example has been described as having a signal strength of 40 on the RSSI scale, which is less than the 50-threshold value. Accordingly, operator 1020 does not pair with the neighbor’s control device 1050.

There could potentially be examples where an unintended control device is activated within the pairing proximity 1106, such as control device 1070 illustrated in FIG. 11. For example, garage 1102 may be part of a condominium community and may share a wall with a garage of a neighboring condo unit. In this example, pairing proximity 1106 could extend into the garage of the neighboring condo, as shown. Thus, while attempting to pair operator 1020 with control device 1000, neighbor’s control device 1070 may be activated and signal 1078 would be received by operator 1020. However, in this example, operator 1020 can include further operational steps to ensure the correct control device is paired with. For example, as will be discussed in greater detail below, operator 1020 can be configured to receive operation signals during its learning mode for a defined signal receiving period of time. During this time, operator 1020 would receive signal 1008 and signal 1078. Operator 1020 will then determine which of signals 1008, 1078 has a greater signal strength, and continue with pairing with the signal strength that is the strongest and also satisfies the signal strength threshold value. Since control device 1070 is further away from operation 1020 than control device 1000, signal 1078 is weaker than signal 1008. For example, signal 1078 may have a RSSI signal strength value of 55, which is greater than the 50 RSSI threshold value, but still less than the 60 RSSI value of signal 1008. Accordingly, operator 1020 will proceed with pairing with control device 1000 rather than control device 1070 since signal 1008 has a stronger signal strength than signal 1078.

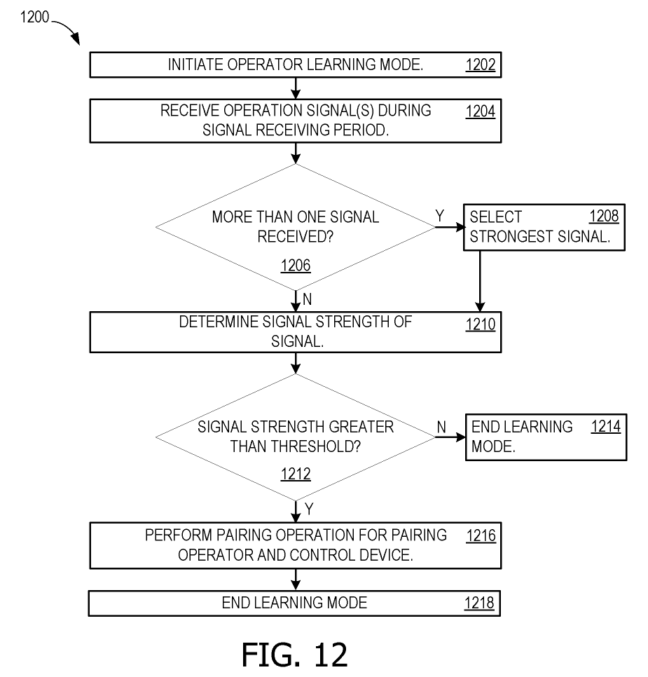

FIG. 12 is a flowchart illustrating a method 1200 of performing a pairing operation of an operator with a control device based on received signal strengths. Method 1200 can begin at block 1202 by initiating a learning mode of operator 1020, such as by as user initiating a learning mode using UI 331, as has been previously described. Method 1200 can continue to block 1204 by controller 302 receiving via communication circuit 308, for a signal receiving period of time of the learning mode, an operation signal of a control device for pairing with operator 1020. Method 1200 can continue to block 1206 where operator controller 302 determines if more than one operation signal is received in the signal receiving period of time. In response to determining that more than one operation signal has been received, method 1200 can continue to block 1208, where operator controller 302 selects a strongest signal of the more than one signals for processing. For example, in the discussion of FIG. 11, operator controller 302 determines signal 1008 is stronger than signal 1078 and proceeds with processing signal 1008 during the pairing operation. After the signal is selected in block 1208, and in response to determining that only one signal is received during the signal receiving period of time in block 1206, method 1200 can continue to block 1210 where operator controller 302 determines the signal strength of the received signal. As previously discussed, this can be done using an absolute value such as a dBm value or an RSSI value. Method 1200 can continue to block 1212 where operator controller 302 determines whether the signal strength of the received signal satisfies the acceptable signal strength threshold value, as has been previously described. In response to determining in block 1212 that the received signal strength is less than the threshold value and thus does not satisfy the threshold (such as signal 1058, for example) method 1200 continues to block 1214 where operator controller 302 terminates the learning mode. In response to determining in block 1212 that the received signal is greater than the threshold value and thus does satisfy the threshold (such as signal 1008, for example) method 1200 continues to block 1216 where operator controller 302 pairs with the control device 1000 from which the received operation signal 1008 was transmitted, substantially the same as described in block 916. Specifically, operator controller 302 can pair with control device 1000 according to the various operations and descriptions discussed herein, such as by storing a GUID and/or signal ID of control device 1000 to memory 304 as an ID belonging to a verified and paired device so that operator 1020 can act upon future signals from control device 1000 that include the stored GUID and/or signal ID, and by the various other pairing descriptions discussed in block 916. Method 1200 can continue block 1218 where, after successfully pairing with control device 1000, operator controller 302 terminates the learning mode operation.

Although method 1200 depicts blocks 1202-1218 as being performed in a certain order, those with skill in the art will understand that blocks 1202-1218 can be performed according to various orders without departing from the scope of this disclosure. Additionally, certain blocks can be removed from or added to method 1200 without departing from the scope of this disclosure.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method for pairing an operating device with a control device, comprising:
initiating a learning mode of the operating device;
capturing, by a sensing device of the operating device, a machine-readable code associated with the control device;
identifying from the machine-readable code, by the operating device, a base identifier (ID) associated with the control device;
transmitting, by the control device, a first signal;
receiving, by the operating device, the first signal;
identifying from the first signal, by the operating device, a first signal ID; and
in response to determining that the first signal ID includes the base ID, pairing the operating device with the control device.

2. The method of claim 1, wherein the operating device pairs with the control device by storing the first signal ID as belonging to a paired device to a memory of the operating device.

3. The method of claim 1, further comprising displaying, by the operating device via a user interface, a notification indicating that the operating device is in a restricted learning mode to learn the control device in response to identifying the base ID from the machine-readable code.

4. The method of claim 1, wherein the operating device comprises an operator for operating a movable barrier and the control device comprises a wireless controller for controlling operations of the operator.

5. The method of claim 1, further comprising, in response to determining that first signal ID does not include the base ID, terminating the learning mode by the operating device.

6. The method of claim 1, further comprising transmitting, by the operating device, a device ID of the operating device to the control device for the control device to use to learn the operating device.

7. The method of claim 1, wherein the machine-readable code is a QR code.

8. The method of claim 1, wherein the machine-readable code is included as part of the control device.

9. The method of claim 8, wherein the machine-readable code is physically depicted on a housing of the control device.

10. The method of claim 8, wherein the machine-readable code is digitally depicted on a digital display of the control device.

11. The method of claim 1, further comprising:
transmitting, by the control device, a second signal different from the first signal; receiving, by the operating device, the second signal; identifying from the second signal, by the operating device, a second signal ID; and in response to determining that the second signal ID includes the base ID, pairing the operating device with the control device.

12. The method of claim 11, wherein the control device transmits:
the first signal in response to receiving a first activation via a user interface of the control device; and the second signal in response to receiving a second activation via a user interface of the control device.

13. The method of claim 1, wherein the base ID is associated with a globally unique identifier (GUID) of the control device and is included as part of every signal transmitted by the control device.

14. A method for pairing an operating device with a control device, comprising:
initiating a learning mode of the operating device;
transmitting, by the control device, an operation signal;
receiving, by the operating device, the operation signal;
determining, by the operating device, a signal strength of the received operation signal;
determining, by the operating device, whether the signal strength of the received operation signal is greater than a signal strength threshold value; and
in response to determining that the signal strength of the received operation signal is greater than the signal strength threshold value, pairing the operating device with the control device.

15. The method of claim 14, wherein the signal strength threshold value corresponds with the control device being disposed within a learning radius of the operating device.

16. The method of claim 14, wherein the operating device comprises an operator for operating a movable barrier and the control device comprises a wireless controller for controlling operations of the operator.

17. The method of claim 14, further comprising, in response to determining that the signal strength of the received operation signal is less than the signal strength threshold value, terminating the learning mode by the operating device.

18. The method of claim 14, wherein, in response to receiving a plurality of the operation signals within a signal receiving period, the operating device is configured to choose an operation signal of the plurality of operation signals with a greatest signal strength for comparing to the signal strength threshold value.

19. The method of claim 14, wherein: the operating device comprises an operator for operating a movable barrier and the control device comprises a wireless controller for controlling operations of the operator; and the signal strength threshold value corresponds with the control device being within a learning radius of the operating device generally corresponding with the area of a room in which the operator is installed.

20. The method of claim 14, wherein the operating device determines the strength of the received operation signal by a Received Signal Strength Indications (RSSI) scale.
